(19) United States
(12) Patent Application Publication
(10) Pub. No.: US 2012/0025957 A1
(43) Pub. Date: Feb. 2, 2012

(54) WIRELESS COMMUNICATION SYSTEM WITH REMOTE CONTROL FUNCTION

(75) Inventor: Chia-Ning Yang, Taipei (TW)

(73) Assignee: COMPAL COMMUNICATION, INC., Taipei (TW)

(21) Appl. No.: 12/954,611

(22) Filed: Nov. 24, 2010

(30) Foreign Application Priority Data
Jul. 28, 2010 (TW) 099124852

(51) Int. Cl. G05B 11/01

(52) U.S. Cl. 340/12.5

(57) ABSTRACT

A wireless communication system includes a first wireless communication module and a second wireless communication module. The first wireless communication module includes at least one wireless receiving/transmitting processing unit configured to receive, transmit and process a data flow including a multimedia data packet and a control data packet. The second wireless communication module includes at least one wireless receiving/transmitting processing unit and a multimedia data outputting unit. The control data packet of the data flow includes a first remote control data packet and a second remote control data packet. The second wireless communication module is remotely controlled by the first wireless communication module according to the first remote control data packet. The first wireless communication module is remotely controlled by the second wireless communication module according to the second remote control data packet.

### CLAIM OF PRIORITY

This application claims priority to Taiwanese Patent Application No. 099124852 filed on Jul. 28, 2010.

### FIELD OF THE INVENTION

The present invention relates to a wireless communication system, and more particularly to a wireless communication system by using a wireless communication protocol with a data flow of a multimedia data packet and a control data packet.

### BACKGROUND OF THE INVENTION

Recently, the general trends in designing portable communication devices are toward small size, light weightiness and fashionable appearance. In addition, diversified functions are imparted to the portable communication devices. For example, the extended functions of a smart phone include an image-capturing function (e.g. likes a digital camera), a wireless communication function (e.g. likes a WiFi and Bluetooth device), an audio and video signal output function (e.g. likes a IPTV box, Apple TV or Google TV box), and a positioning function (e.g. likes a global positioning system). For implementing the audio and video signal output function, the Composite audio and video output interface (AV-out) or HDMI interface of the smart phone is connected with an external display device (e.g. a TV set or a LCD display) through a signal transmission line. As a consequence, the audio and video multimedia data stored in the smart phone may be viewed through a larger screen, or the displaying image of the smart phone may be simultaneously displayed on dual screens. The use of the signal transmission line to transmit the audio and video multimedia data, however, is not user-friendly because of the length limitation of the signal transmission line. For solving this drawback, the audio and video multimedia data may be transmitted according to a wireless transmission technology.

According to progress of Cloud Computing Technology, low cost internet access device and wireless display devices such as wireless LCD, wireless projector, wireless head mounted display and smart phone are more user-friendly to compare with wired display devices to be used in this application. According to more popular of IPTV box, Apple TV and Google TV box, wireless display devices such as wireless LCD, wireless projector, wireless head mounted display and smart phone are more user-friendly to compare with wired display devices to be used in this application.

E-book and robot with input and output function are more popular but the functions are constrained by internal CPU. There is one method without increasing the performance of internal CPU as Cloud Computing Technology to distribute some functions to other CPU such as CPU of personal computer by using low cost wireless technology communication.

Generally, the method for transmitting the audio and video multimedia data according to the wireless transmission technology is implemented by an IEEE standard digital protocol wireless network system (e.g. WiFi, WLAN IEEE802.1x, Bluetooth IEEE802.15.1, UWB IEEE802.15.3), a non-IEEE standard digital protocol wireless network system (ISM band wireless devices, WHDI, WIDI) or an analog wireless network system (ISM band wireless devices). Generally, the method for transmitting the control data according to the wireless transmission technology is implemented by an IEEE standard digital protocol wireless network system (e.g. Bluetooth IEEE802.15.1, Zigbee IEEE802.15.4, WiFi WLAN IEEE802.1x), a non-IEEE standard digital protocol wireless network system (ISM band wireless devices) or an analog wireless network system (ISM band wireless devices). Since the IEEE standard digital protocol wireless network system uses a complex synergistic computation to process the audio and video multimedia data, the method of producing the IEEE standard digital protocol wireless network system is time-consuming and costly. Since the transmission of the audio and video multimedia data is readily interfered by the external noise, the data transmission quality of the analog wireless network system is non-security, deteriorated, and even an erroneous transmission problem may occur. On the other hand, for the non-IEEE standard digital protocol wireless network system, the complex synergistic computation is not necessary. In addition, the non-IEEE standard digital protocol wireless network system is more cost-effective and easily designed when compared with the IEEE standard digital protocol wireless network system and has better transmission quality when compared with the analog wireless network system. Consequently, the non-IEEE standard digital protocol wireless technology is gradually adopted in many products but the most popular system is still IEEE standard digital protocol wireless network system.

As known, the external display device for receiving audio and video multimedia data fails to be directly and remotely controlled by the smart phone. In addition, the common infrared remote control devices and Zigbee remote control devices still fail to be directly and remotely controlled by the smart phone. For controlling the external display device or the infrared remote control devices or the Zigbee remote control devices by the smart phone, the smart phone may be equipped with some additional components such as an infrared remote control chip, a Zigbee transceiver chip and/or a Zigbee antenna. Through these components, an infrared control signal and an IEEE standard Zigbee control signal are generated to remote control TV sets, the infrared remote control devices or the Zigbee remote control devices. Since the additional components occupy much space of the smart phone, the overall volume and thickness of the smart phone fail to be further reduced. In addition, many components mean that the power consumption and the circuitry complexity of the smart phone are increased.

Recently, a tablet personal computer with a touch control function (e.g. a touchpad PC), a LCD display with a touch control function, a projector, or a head mounted display becomes more popular. By touching the screen or inputting an instruction, the tablet personal computer, the wireless LCD display, the wireless projector, or the wireless head mounted display may execute a corresponding function according to a touch or data input control technology. However, the tablet personal computer and the wireless display devices, which have a touch or data input control function, still fail to remotely control smart phone which can provide multimedia data of audio and video out function. In other words, the applications of the smart phone are restricted.

The wireless display devices can not send HIDs signal to internet access device, IPTV box, Apple TV or Google TV box therefore the system functions are constrained. E-book and robot with input and output function can not send HIDs signal to remote control CPU, therefore the system functions are constrained.

### SUMMARY OF THE INVENTION

The present invention provides a wireless communication system comprising a first wireless communication module and a second wireless communication module. A multimedia data packet and a control data packet of a data flow are transmitted between the first wireless communication module and the second wireless communication module according to the wireless communication protocol by integrating with a non-IEEE standard digital protocol wireless system, an IEEE standard digital protocol wireless network system or an analog wireless network system and by employing a symmetric data transmission technology or an asymmetric data transmission technology. Accordingly, the multimedia data packet provided by the first wireless communication module may be played or outputted by the second wireless communication module, and the first wireless communication module and the second wireless communication module may be remotely controlled by each other according to the control data packet.

The present invention also provides a wireless communication system comprising a first wireless communication module and a second wireless communication module, in which the first wireless communication module is simple, power-saving, cost-effective and user-friendly or is existent wireless communication modules. For example a smart Phone application could be non-IEEE standard digital protocol wireless network system (ISM band) to use one pair of processors to process video, audio and control data without largely increasing the loading of the processor of the second wireless communication module or to use existent components of smart phone as Wifi for video and audio and Bluetooth for control data without the additional components to occupy much space of the smart phone to increase functions of smart phone.

In accordance with an aspect of the present invention, there is provided a wireless communication system with a remote control function. The wireless communication system includes a first wireless communication module and a second wireless communication module. The first wireless communication module includes a first wireless receiving/transmitting processing unit or a first wireless receiving/transmitting processing unit and a third wireless receiving/transmitting processing unit. The first wireless receiving/transmitting processing unit is configured to receive, transmit and process a data flow complying with a non-IEEE standard communication protocol. The data flow includes a multimedia data packet and a control data packet. Or the first wireless receiving/transmitting processing unit is for the multimedia data packet and the third wireless receiving/transmitting processing unit is for the control data packet. The second wireless communication module includes a second wireless receiving/transmitting processing unit and a multimedia data outputting unit or a second wireless receiving/transmitting processing unit, a fourth wireless receiving/transmitting processing unit and a multimedia data outputting unit. The second wireless receiving/transmitting processing unit is configured to receive, transmit and process the data flow complying with a non-IEEE standard communication protocol. The data flow includes a multimedia data packet and a control data packet. Or the second wireless receiving/transmitting processing unit is for the multimedia data packet and the fourth wireless receiving/transmitting processing unit is for the control data packet. A multimedia data signal contained in the multimedia data packet is outputted from the multimedia data outputting unit. Preferably, the data flow is wirelessly transmitted between the first wireless communication module and the second wireless communication module according to the non-IEEE standard communication protocol. The control data packet of the data flow includes a first remote control data packet and a second remote control data packet. The first remote control data packet contains an infrared remote control signal, a Zigbee remote control signal or a switcher remote control signal so that the second wireless communication module is remotely controlled by the first wireless communication module according to the first remote control data packet, and the second remote control data packet contains a touch remote control signal, a joystick remote control signal, a click remote control signal, a mouse cursor remote control signal or a keyboard input remote control signal (HIDs signal) so that the first wireless communication module is remotely controlled by the second wireless communication module according to the second remote control data packet.

In accordance with another aspect of the present invention, there is provided a wireless communication system with a remote control function. The wireless communication system includes a first wireless communication module and a second wireless communication module. The first wireless communication module includes a first wireless receiving/transmitting processing unit or a first wireless receiving/transmitting processing unit and a third wireless receiving/transmitting processing unit. The first wireless receiving/transmitting processing unit is configured to receive, transmit and process a data flow complying with a non-IEEE standard communication protocol. The data flow includes a multimedia data packet and a control data packet. Or the first wireless receiving/transmitting processing unit is for the multimedia data packet and the third wireless receiving/transmitting processing unit is for the control data packet. The second wireless communication module includes a second wireless receiving/transmitting processing unit and a multimedia data outputting unit or a second wireless receiving/transmitting processing unit, a fourth wireless receiving/transmitting processing unit and a multimedia data outputting unit. The second wireless receiving/transmitting processing unit is configured to receive, transmit and process the data flow complying with a non-IEEE standard communication protocol. The data flow includes a multimedia data packet and a control data packet. Or the second wireless receiving/transmitting processing unit is for the multimedia data packet and the fourth wireless receiving/transmitting processing unit is for the control data packet. A multimedia data signal contained in the multimedia data packet is outputted from the multimedia data outputting unit. Preferably, the data flow is wirelessly transmitted between the first wireless communication module and the second wireless communication module according to the non-IEEE standard communication protocol. The control data packet of the data flow contains a touch remote control signal, a joystick remote control signal, a click remote control signal, a mouse cursor remote control signal or a keyboard input remote control signal (HIDs signal) so that the first wireless communication module is remotely controlled by the second wireless communication module according to the control data packet.

In accordance with another aspect of the present invention, there is provided a wireless communication system with a remote control function. The wireless communication system includes a first wireless communication module and a second wireless communication module. The first wireless communication module includes a first wireless receiving/transmitting processing unit or a first wireless receiving/transmitting processing unit and a third wireless receiving/transmitting processing unit. The first wireless receiving/transmitting processing unit is configured to receive, transmit and process a data flow complying with a non-IEEE standard communication protocol. The data flow includes a multimedia data packet and a control data packet. The second wireless communication module includes a second wireless receiving/transmitting processing unit and a multimedia data outputting unit or a second wireless receiving/transmitting processing unit, a fourth wireless receiving/transmitting processing unit and a multimedia data outputting unit. The second wireless receiving/transmitting processing unit is configured to receive, transmit and process the data flow. The data flow includes a multimedia data packet and a control data packet. Or the second wireless receiving/transmitting processing unit is for the multimedia data packet and the fourth wireless receiving/transmitting processing unit is for the control data packet. A multimedia data signal contained in the multimedia data packet is outputted from the multimedia data outputting unit. Preferably, the data flow is wirelessly transmitted between the first wireless communication module and the second wireless communication module according to the non-IEEE standard communication protocol. The control data packet of the data flow contains an infrared remote control signal, a Zigbee remote control signal or a switcher remote control signal so that the second wireless communication module is remotely controlled by the first wireless communication module according to the control data packet.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic functional block diagram illustrating a wireless communication system according to an embodiment of the present invention;

FIG. 1B is a schematic functional block diagram illustrating a wireless communication system according to another embodiment of the present invention;

FIG. 1C is a schematic diagram illustrating the architecture of the wireless communication system as shown in FIGS. 1A and 1B;

FIG. 2 is a schematic diagram illustrating a data flow processed in the wireless communication system of FIG. 1;

FIG. 3A is a schematic functional block diagram illustrating a wireless communication system according to another embodiment of the present invention;

FIG. 3B is a schematic functional block diagram illustrating a variant of the wireless communication system as shown in FIG. 3A;

FIG. 4A is a schematic functional block diagram illustrating an exemplary first wireless communication module used in the wireless communication system of the present invention;

FIG. 4B is a schematic functional block diagram illustrating another exemplary first wireless communication module used in the wireless communication system of the present invention;

FIG. 4C is a schematic functional block diagram illustrating a further exemplary first wireless communication module used in the wireless communication system of the present invention;

FIG. 5A is a schematic functional block diagram illustrating an exemplary second wireless communication module used in the wireless communication system of the present invention;

FIG. 5B is a schematic functional block diagram illustrating another exemplary second wireless communication module used in the wireless communication system of the present invention;

FIG. 5C is a schematic functional block diagram illustrating a further exemplary second wireless communication module used in the wireless communication system of the present invention; and

FIG. 5D is a schematic functional block diagram illustrating a further exemplary second wireless communication module used in the wireless communication system of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

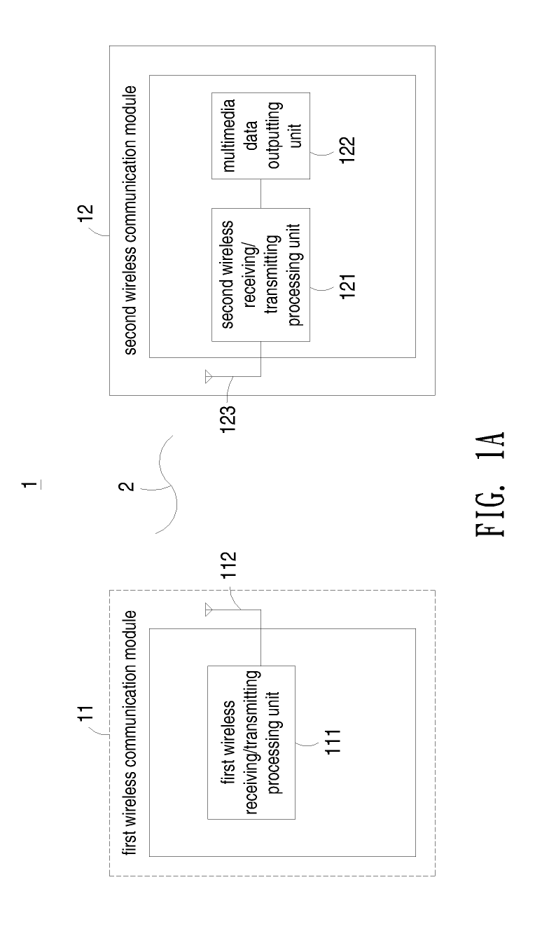

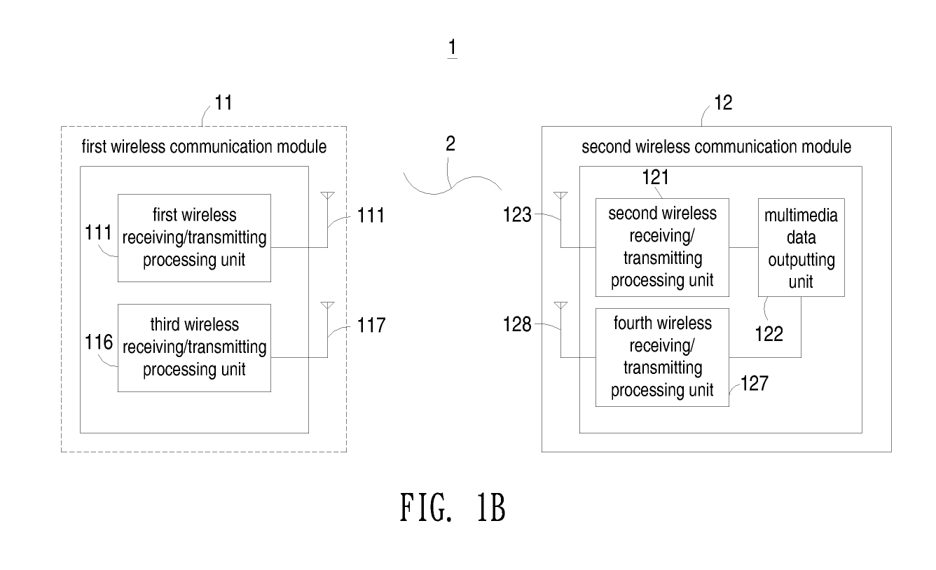

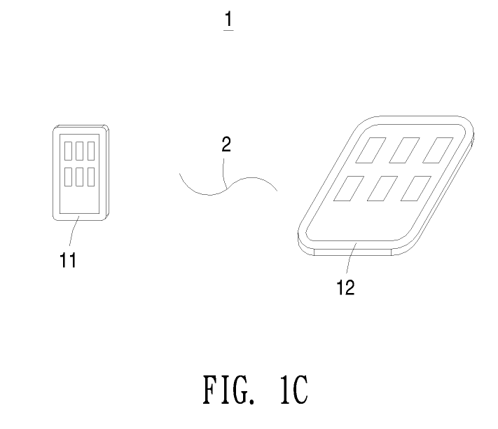

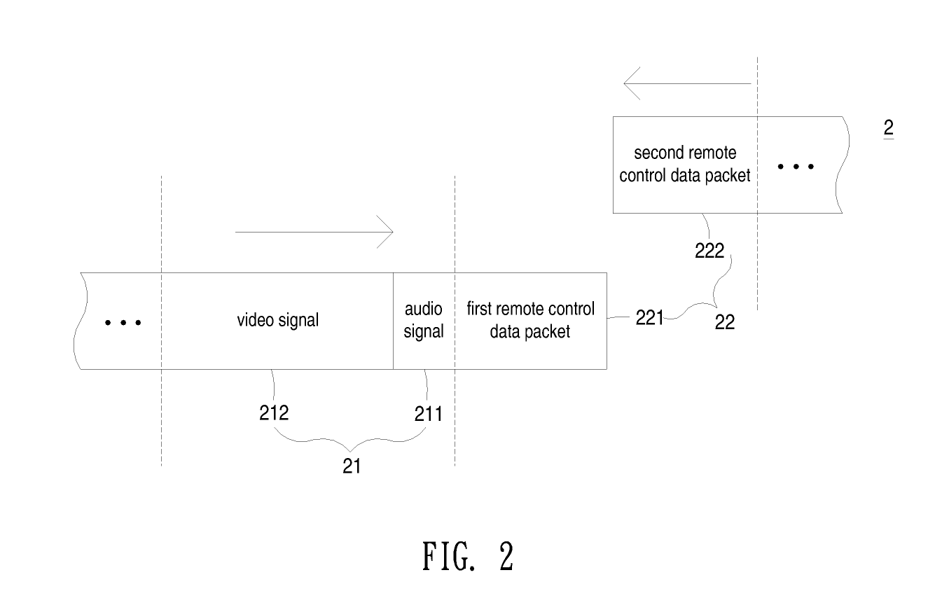

FIG. 1A is a schematic functional block diagram illustrating a wireless communication system according to an embodiment of the present invention. FIG. 1B is a schematic functional block diagram illustrating a wireless communication system according to another embodiment of the present invention. FIG. 1C is a schematic diagram illustrating the architecture of the wireless communication system such as non-IEEE standard digital protocol wireless system, IEEE standard digital protocol wireless network system or analog wireless network system as shown in FIGS. 1A and 1B. FIG. 2 is a schematic diagram illustrating a data flow processed in the wireless communication system of FIG. 1. Please refer to FIGS. 1A, 1C and 2. The wireless communication system 1 comprises a first wireless communication module 11 and a second wireless communication module 12. The first wireless communication module 11 has a first wireless receiving/transmitting processing unit 111. Preferably, the first wireless receiving/transmitting processing unit 111 is configured to receive, transmit and process the data flow 2 that complies with a non-IEEE standard communication protocol. The data flow 2 comprises a multimedia data packet 21 and a control data packet 22. The second wireless communication module 12 comprises a second wireless receiving/transmitting processing unit 121 and a multimedia data outputting unit 122. The second wireless receiving/transmitting processing unit 121 is configured to receive, transmit and process the data flow 2. The multimedia data outputting unit 122 is used for outputting the multimedia data signal contained in the multimedia data packet 21. Preferably, the data flow 2 is transmitted between the first wireless communication module 11 and the second wireless communication module 12 according to the non-IEEE standard communication protocol. The control data packet 22 of the data flow 2 comprises at least one of a first remote control data packet 221 and a second remote control data packet 222. The first remote control data packet 221 and the multimedia data packet 21 are transmitted in the same direction. The second remote control data packet 222 and the multimedia data packet 21 are transmitted in opposite directions. The second wireless communication module 12 is remotely controlled according to the first remote control data packet 221. The first wireless communication module 11 is remotely controlled according to the second remote control data packet 222. In this embodiment, the multimedia data packet 21 of the data flow 2 is transmitted from the first wireless communication module 11 to the second wireless communication module 12 according to the non-IEEE standard communication protocol. In an embodiment, the multimedia data packet 21 of the data flow 2 comprises at least one audio signal 211 and at least one video signal 212.

Please refer to FIGS. 1A, 1C and 2 again. An example of the first wireless communication module 11 includes but is not limited to a mobile phone. For transmitting the multimedia data from the first wireless communication module 11 to the second wireless communication module 12 to be played or outputted, the multimedia data is firstly converted into the data flow 2 (e.g. in a digital format) by the first wireless receiving/transmitting processing unit 111 of the first wireless communication module 11, and then the data flow 2 is transmitted from the first wireless communication module 11 to the second wireless communication module 12 through the antenna 112 according to the non-IEEE standard communication protocol. The data flow 2 is received by the second wireless communication module 12 through the antenna 123, and then processed by the second wireless receiving/transmitting processing unit 121. The multimedia data signal contained in the multimedia data packet 21 will be played or outputted by the multimedia data outputting unit 122. In such way, the efficacy of displaying a larger image or simultaneously displaying on dual screens will be achieved.

Moreover, during the multimedia data is transmitted from the first wireless communication module 11 to the second wireless communication module 12 to be played or outputted, the second wireless communication module 12 may be remotely controlled. By the first wireless receiving/transmitting processing unit 111 of the first wireless communication module 11, the multimedia data and a first remote control signal are respectively converted into the multimedia data packet 21 and the first remote control data packet 221 of the data flow 2. The first remote control data packet 221 and the multimedia data packet 21 are transmitted in the same direction. For example, the first remote control data packet 221 and the multimedia data packet 21 are transmitted in a first direction from the first wireless communication module 11 to the second wireless communication module 12. According to the non-IEEE standard communication protocol, the data flow 2 is transmitted to the second wireless communication module 12 through the antenna 112 of the first wireless communication module 11. After the data flow 2 is received by the second wireless communication module 12 through the antenna 123, the data flow 2 is analyzed and processed by the second wireless receiving/transmitting processing unit 121. Then, the multimedia data signal contained in the multimedia data packet 21 will be played or outputted by the multimedia data outputting unit 122. Moreover, through the second wireless receiving/transmitting processing unit 121, the second wireless communication module 12 is remotely controlled by the first wireless communication module 11 according to the first remote control data packet 221.

An example of the second wireless communication module 12 includes but is not limited to a tablet personal computer or a monitor, which has wireless communication and touch control functions. For remotely controlling the first wireless communication module 11 by the second wireless communication module 12, a second remote control signal is firstly converted into the second remote control data packet 222 of the data flow 2 by the second wireless receiving/transmitting processing unit 121 of the second wireless communication module 12. The second remote control data packet 222 and the multimedia data packet 21 are transmitted in opposite directions. For example, the second remote control data packet 222 is transmitted in a second direction from the second wireless communication module 12 to the first wireless communication module 11.

According to the non-IEEE standard communication protocol, the data flow 2 is transmitted to the first wireless communication module 11 through the antenna 123 of the second wireless communication module 12. After the data flow 2 is received by the first wireless communication module 11 through the antenna 112, the data flow 2 is analyzed and processed by the first wireless receiving/transmitting processing unit 111. Moreover, through the first wireless receiving/transmitting processing unit 111, the first wireless communication module 11 is remotely controlled by the second wireless communication module 12 according to the second remote control data packet 222.

In some embodiments, a second remote control signal is directly inputted into the second wireless communication module 12 through a human-machine interface (not shown in FIG. 1), then converted into the second remote control data packet 222 of data flow 2 by the second wireless receiving/transmitting processing unit 121, and transmitted through the antenna 123. In some embodiment, the second remote control signal comprises at least one touch remote control signal, at least one joystick remote control signal, at least one click remote control signal, at least one mouse cursor remote control signal and/or at least one keyboard input remote control signal (HIDs signal).

In the wireless communication system 1, the multimedia data packet 21 and the control data packet 22 of the data flow 2 are wirelessly transmitted according to a symmetric data transmission technology or an asymmetric data transmission technology. According to the asymmetric data transmission technology, the multimedia data packet 21 is transmitted from the first wireless communication module 11 to the second wireless communication module 12 through a higher frequency band of a transmission channel, and the second remote control data packet 222 of the control data packet 22 is transmitted from the second wireless communication module 12 to the first wireless communication module 11 through a lower frequency band of the transmission channel. As a consequence, the unidirectional transmission bandwidth of the transmission channel will be increased and the speed of transmitting the multimedia data packet 21 is enhanced.

In some embodiments, the first wireless communication module 11 is for example, a smart phone, an internet access device, a combination of a smart phone and a mobile battery, a personal digital assistant, a notebook computer, an IPTV box, an Apple TV, a Google TV box, a PC or a tablet personal computer. In some embodiments, the second wireless communication module 12 is for example a wirelessly-controlled and touch-controlled monitor, a combination of a monitor and a wireless communication adapter, an e-book, a robot, a wireless projector, a combination of a projector and a wireless communication adapter, a wireless head mounted display, a combination of a head mounted display and a wireless communication adapter, a smart phone or a tablet personal computer.

From the above description, in the wireless communication system 1, the multimedia data may be transmitted between the first wireless communication module 11 and the second wireless communication module 12 in a unidirectional manner, and the remote control signal may be transmitted between the first wireless communication module 11 and the second wireless communication module 12 in a bidirectional manner. In some embodiment, the multimedia data and the remote control signal are both transmitted between the first wireless communication module 11 and the second wireless communication module 12 in the unidirectional manner.

Alternatively, as shown in FIGS. 1B and 1C, the wireless communication system 1 comprises a first wireless communication module 11 and a second wireless communication module 12. The first wireless communication module 11 has a first wireless receiving/transmitting processing unit 111 and a third wireless receiving/transmitting processing unit 116. Preferably, the first wireless receiving/transmitting processing unit 111 is configured to receive, transmit and process the multimedia data packet of the data flow, and the third wireless receiving/transmitting processing unit 116 is configured to receive, transmit and process the control data packet of the data flow. The second wireless communication module 12 comprises a second wireless receiving/transmitting processing unit 121, a fourth wireless receiving/transmitting processing unit 127 and a multimedia data outputting unit 122. Preferably, the second wireless receiving/transmitting processing unit 121 is configured to receive, transmit and process the multimedia data packet of the data flow, and the fourth wireless receiving/transmitting processing unit 127 is configured to receive, transmit and process the control data packet of the data flow. The multimedia data outputting unit 122 is used for outputting the multimedia data signal contained in the multimedia data packet. Preferably, the data flow is transmitted between the first wireless communication module 11 and the second wireless communication module 12 according to the wireless communication protocol by integrating with non-IEEE standard digital protocol wireless system, IEEE standard digital protocol wireless network system or analog wireless network system and by employing a symmetric data transmission technology or an asymmetric data transmission technology.

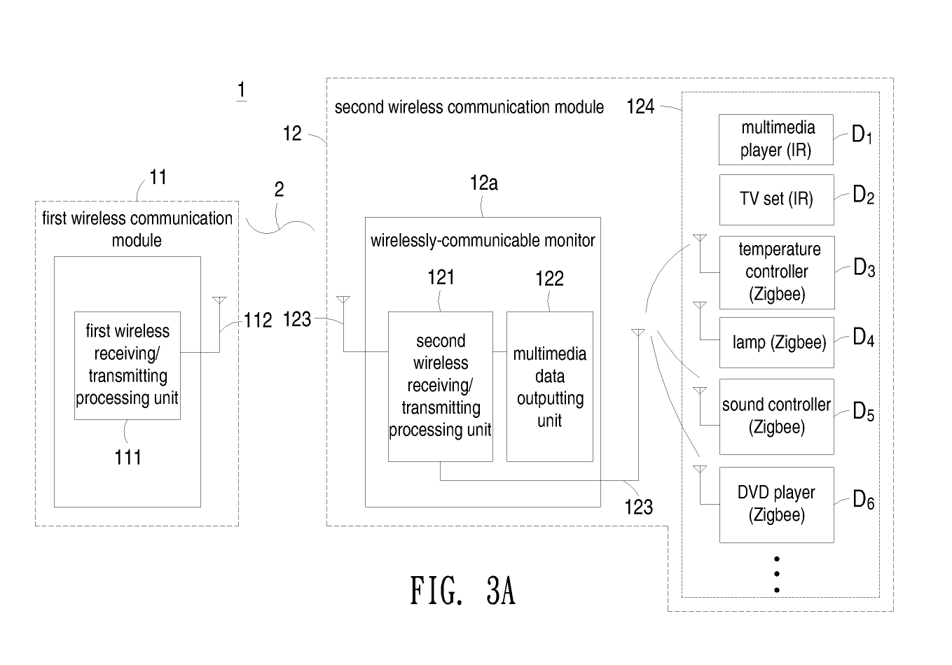

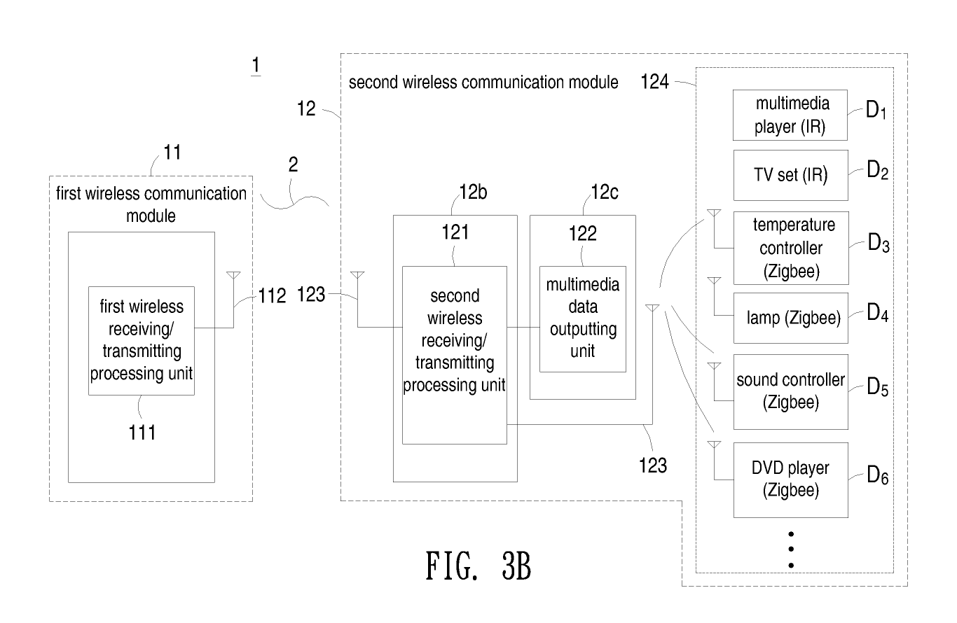

FIG. 3A is a schematic functional block diagram illustrating a wireless communication system according to another embodiment of the present invention. FIG. 3B is a schematic functional block diagram illustrating a variant of the wireless communication system as shown in FIG. 3A. As shown in FIG. 3A, the wireless communication system 1 comprises a first wireless communication module 11 and a second wireless communication module 12. The first wireless communication module 11 has a first wireless receiving/transmitting processing unit 111. The first wireless receiving/transmitting processing unit 111 is configured to receive, transmit and process the data flow 2 that complies with a non-IEEE standard communication protocol. The data flow 2 comprises at least one multimedia data packet 21 and a control data packet 22. The second wireless communication module 12 comprises a second wireless receiving/transmitting processing unit 121, a multimedia data outputting unit 122 and one or more remotely-controlled electronic devices 124. For example, the remotely-controlled electronic devices 124 include infrared remote control devices D1-D2 and Zigbee remote control devices D3-D6. In this embodiment, the second wireless receiving/transmitting processing unit 121 and the multimedia data outputting unit 122 may be integrated into a wirelessly-communicable monitor 12a. The second wireless receiving/transmitting processing unit 121 is configured to receive, transmit and process the data flow 2. The multimedia data outputting unit 122 is used for outputting the multimedia data signal contained in the multimedia data packet 21.

In this embodiment, the data flow 2 is wirelessly transmitted between the first wireless communication module 11 and the second wireless communication module 12 according to the non-IEEE standard communication protocol. The control data packet 22 of the data flow 2 comprises a first remote control data packet 221. The first remote control data packet 221 and the multimedia data packet 21 are transmitted in the same direction. The second wireless communication module 12 is remotely controlled according to the first remote control data packet 221. In this embodiment, the multimedia data packet 21 of the data flow 2 is transmitted from the first wireless communication module 11 to the second wireless communication module 12 according to the non-IEEE standard communication protocol. In an embodiment, the multimedia data packet 21 of the data flow 2 comprises at least one audio signal 211 and at least one video signal 212.

In this embodiment, the first remote control data packet 221 comprises at least one infrared remote control signal and/or at least one Zigbee remote control signal. In some embodiments, the second wireless receiving/transmitting processing unit 121 and the multimedia data outputting unit 122 may be included in the same casing. Alternatively, the second wireless receiving/transmitting processing unit 121 and the multimedia data outputting unit 122 may be discretely disposed within different casings. For example, as shown in FIG. 3B, the second wireless receiving/transmitting processing unit 121 and the multimedia data outputting unit 122 are respectively formed as a wireless communication adapter 12b and a monitor 12c.

In some embodiments, the first wireless communication module 11 is for example, a smart phone, an internet access device, a combination of a smart phone and a mobile battery, a personal digital assistant, a notebook computer, an IPTV box, an Apple TV, a Google TV box, a PC or a tablet personal computer. In some embodiments, the second wireless communication module 12 is for example a wirelessly-controlled and touch-controlled monitor, a combination of a monitor and a wireless communication adapter, an e-book, a robot, a wireless projector, a combination of a projector and a wireless communication adapter, a wireless head mounted display, a combination of a head mounted display and a wireless communication adapter, a smart phone or a tablet personal computer. In this embodiment, the remotely-controlled electronic devices 124 include infrared remote control devices (e.g. a multimedia player D1 and a TV set D2) and Zigbee remote control devices (e.g. an air-conditioning system's temperature controller D3, a lamp D4, a sound device's remote controller D5 and a DVD player D6).

Please refer to FIGS. 3A and 3B again. After the data flow 2 from the first wireless communication module 11 is received by the second wireless communication module 12, the data flow 2 is analyzed and processed by the second wireless receiving/transmitting processing unit 121. Then, the multimedia data packet 21 of the data flow 2 is transmitted from the second wireless receiving/transmitting processing unit 121 to the multimedia data outputting unit 122 (e.g. a monitor), so that the multimedia data signal contained in the multimedia data packet 21 will be displayed on a larger screen. Moreover, the first remote control data packet 221 of the control data packet 22 of the data flow 2 is also analyzed and processed by the second wireless receiving/transmitting processing unit 121. In a case that the first remote control data packet 221 contains the infrared remote control signal and/or the Zigbee remote control signal, the infrared remote control signal and/or the Zigbee remote control signal will be directly transmitted to the remotely-controlled electronic devices 124 or transmitted to the remotely-controlled electronic devices 124 through the antenna 123. The remotely-controlled electronic devices 124 include infrared remote control devices (e.g. a multimedia player D1 and a TV set D2) and Zigbee remote control devices (e.g. an air-conditioning system's temperature controller D3, a lamp D4, a sound device's remote controller D5 and a DVD player D6). In such way, one or more remotely-controlled electronic devices 124 can be remotely controlled by a single smart phone.

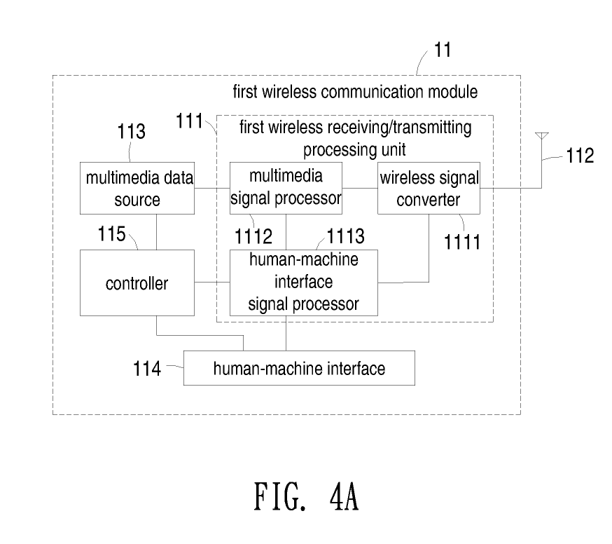

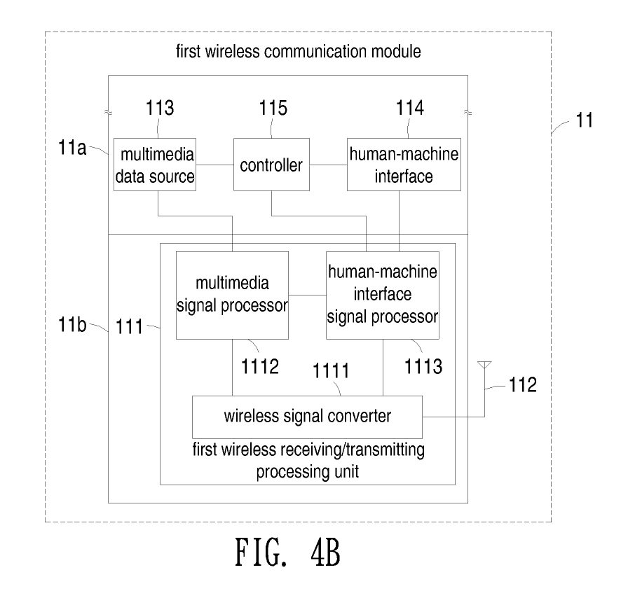

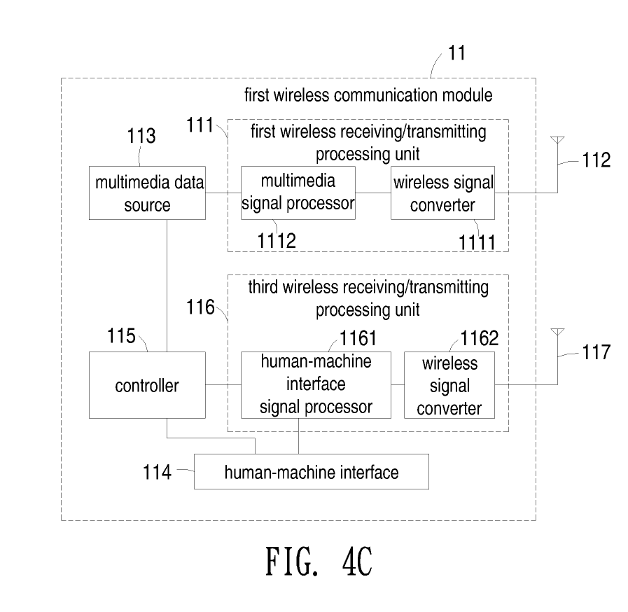

FIG. 4A is a schematic functional block diagram illustrating an exemplary first wireless communication module used in the wireless communication system of the present invention. As shown in FIG. 4A, the first wireless communication module 11 is an integrated smart phone comprising a first wireless receiving/transmitting processing unit 111, an antenna 112, a multimedia data source 113, a human-machine interface 114 and a controller 115. The first wireless receiving/transmitting processing unit 111 comprises a wireless signal converter 1111, a multimedia signal processor 1112 and a human-machine interface signal processor 1113. The human-machine interface signal processor 1113 is connected with the multimedia signal processor 1112. The human-machine interface 114 is connected with the multimedia data source 113. The controller 115 is connected with the human-machine interface signal processor 1113, the multimedia data source 113 and the human-machine interface 114 for controlling operations of the first wireless communication module 11. The multimedia data source 113 is used for providing a multimedia data to the first wireless receiving/transmitting processing unit 111. In response to a control action or a touch control action of the user, the human-machine interface 114 issues a human-machine interface signal. After the human-machine interface signal is processed by the human-machine interface signal processor 1113, a first remote control signal is generated. The multimedia data and the first remote control signal are converted by the wireless signal converter 1111 into the data flow 2, which complies with a non-IEEE standard communication protocol. The data flow 2 is transmitted through the antenna 112.

Moreover, the data flow 2 from the second wireless communication module 12 may be received by the first wireless receiving/transmitting processing unit 111 through the antenna 112. The data flow 2 further comprises a second remote control data packet 222. The second remote control signal contained in the second remote control data packet 222 may be further processed by the wireless signal converter 1111 and the human-machine interface signal processor 1113, and then transmitted to the controller 115. According to the second remote control signal, the operations of the first wireless communication module 11 will be controlled by the controller 115.

FIG. 4B is a schematic functional block diagram illustrating another exemplary first wireless communication module used in the wireless communication system of the present invention. As shown in FIG. 4B, the first wireless communication module 11 is a combination of a smart phone 11a and a mobile battery 11b. The first wireless communication module 11 comprises a first wireless receiving/transmitting processing unit 111, an antenna 112, a multimedia data source 113, a human-machine interface 114 and a controller 115. The first wireless receiving/transmitting processing unit 111 and the antenna 112 are included in the casing of the mobile battery 11b. The multimedia data source 113, the human-machine interface 114 and the controller 115 are included in the casing of the small phone 11a. The operating principles and the functions of the components of the first wireless communication module shown in FIG. 4B are similar to those shown in FIG. 4A, and are not redundantly described herein.

FIG. 4C is a schematic functional block diagram illustrating a further exemplary first wireless communication module used in the wireless communication system of the present invention. The first wireless communication module 11 comprises a first wireless receiving/transmitting processing unit 111, an antenna 112, a multimedia data source 113, a human-machine interface 114, a controller 115, a third wireless receiving/transmitting processing unit 116 and an antenna 117. The first wireless receiving/transmitting processing unit 111 comprises a multimedia signal processor 1112 and a wireless signal converter 1111. The first wireless receiving/transmitting processing unit 111 is configured to receive, transmit and process the multimedia data packet of the data flow. The third wireless receiving/transmitting processing unit 116 comprises a human-machine interface signal processor 1161 connected to the controller 115 and the human-machine interface 114 and a wireless signal converter 1162 connected to the human-machine interface signal processor 1161 and the antenna 117. The third wireless receiving/transmitting processing unit 116 is configured to receive, transmit and process the control data packet of the data flow. The operating principles and the functions of the components of the first wireless communication module shown in FIG. 4C are similar to those shown in FIG. 4A, and are not redundantly described herein.

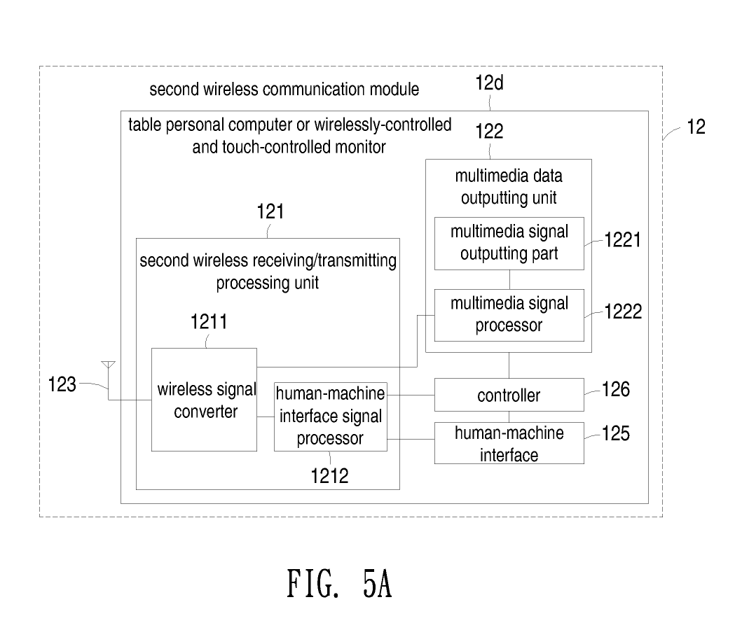

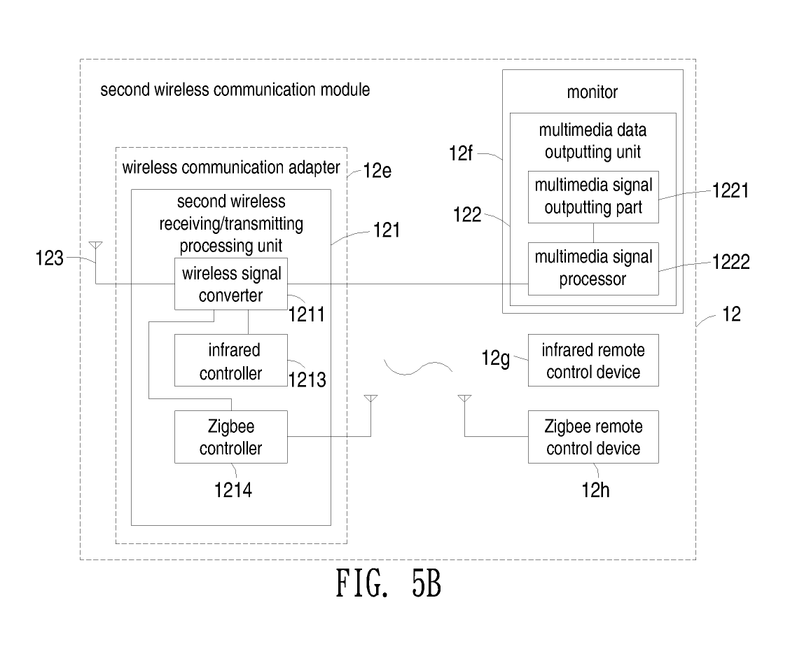

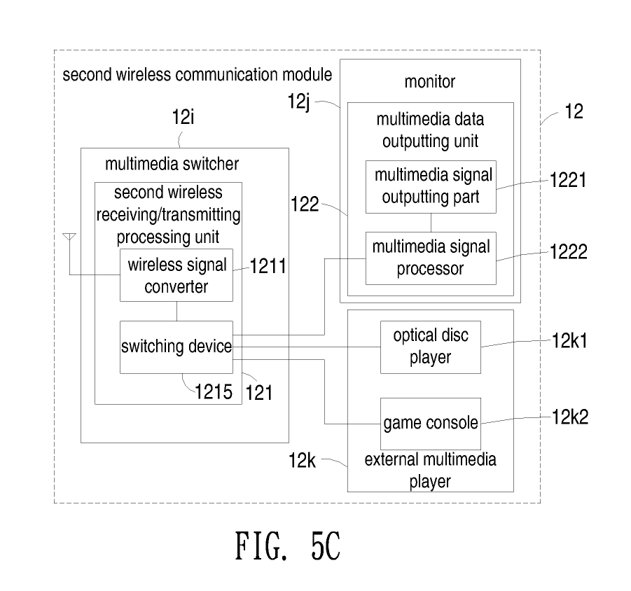

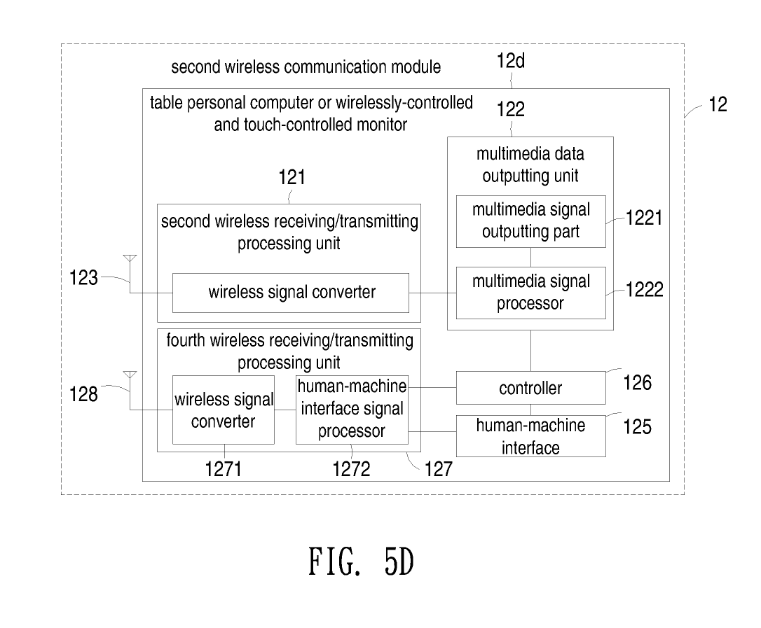

FIG. 5A is a schematic functional block diagram illustrating an exemplary second wireless communication module used in the wireless communication system of the present invention. As shown in FIG. 5A, the second wireless communication module 12 is a tablet personal computer or a wirelessly-controlled and touch-controlled monitor 12d. The second wireless communication module 12 comprises a second wireless receiving/transmitting processing unit 121, a multimedia data outputting unit 122, an antenna 123, a human-machine interface 125 and a controller 126. The second wireless receiving/transmitting processing unit 121 comprises a wireless signal converter 1211 and a human-machine interface signal processor 1212. The human-machine interface signal processor 1212 is connected with the wireless signal converter 1211. The multimedia data outputting unit 122 comprises a multimedia signal outputting part 1221 and a multimedia signal processor 1222. The multimedia signal processor 1222 is connected with the wireless signal converter 1211 of the second wireless receiving/transmitting processing unit 121 and the multimedia signal outputting part 1221. After the data flow 2 received from the second wireless receiving/transmitting processing unit 121 is processed by the multimedia signal processor 1222, the multimedia data signal contained in the multimedia data packet 21 will be played and outputted by the multimedia signal outputting part 1221. The human-machine interface 125 is connected with the human-machine interface signal processor 1212 of the second wireless receiving/transmitting processing unit 121. The controller 126 is connected with the human-machine interface signal processor 1212 of the second wireless receiving/transmitting processing unit 121, the human-machine interface 125 and the multimedia data outputting unit 122 for controlling operations of the second wireless communication module 12. In addition, according to the first remote control signal contained in the first remote control data packet 221, the operations of the second wireless communication module 12 is controlled by the controller 126. In response to a control action or a touch control action of the user, the human-machine interface 125 issues a human-machine interface signal. After the human-machine interface signal is processed by the human-machine interface signal processor 1212 of the second wireless receiving/transmitting processing unit 121, a second remote control signal is generated. The second remote control signal is converted by the wireless signal converter 1211 into the data flow 2, which complies with the non-IEEE standard communication protocol. The data flow 2 is transmitted through the antenna 123.

FIG. 5B is a schematic functional block diagram illustrating another exemplary second wireless communication module used in the wireless communication system of the present invention. As shown in FIG. 5B, the second wireless communication module 12 comprises a wireless communication adapter 12e, a monitor 12f, an infrared remote control device 12g and a Zigbee remote control device 12h. The wireless communication adapter 12e comprises a second wireless receiving/transmitting processing unit 121. The second wireless receiving/transmitting processing unit 121 comprises a wireless signal converter 1211, an infrared controller 1213 and a Zigbee controller 1214. The infrared controller 1213 and the Zigbee controller 1214 are connected with the wireless signal converter 1211. The first remote control data packet 221 from the wireless signal converter 1211 are processed by the infrared controller 1213 and the Zigbee controller 1214, thereby acquiring an infrared remote control signal and a Zigbee remote control signal, respectively. Consequently, the infrared remote control device 12g and the Zigbee remote control device 12h are respectively controlled by the infrared controller 1213 and the Zigbee controller 1214 according to the infrared remote control signal and the Zigbee remote control signal.

In this embodiment, the multimedia data outputting unit 122 of the monitor 12f comprises a multimedia signal outputting part 1221 and a multimedia signal processor 1222. The multimedia signal processor 1222 is connected with the wireless signal converter 1211 of the second wireless receiving/transmitting processing unit 121. The multimedia data contained in the multimedia data packet from the second wireless receiving/transmitting processing unit 121 is processed by the multimedia signal processor 1222, and then played and outputted by the multimedia signal outputting part 1221.

FIG. 5C is a schematic functional block diagram illustrating a further exemplary second wireless communication module used in the wireless communication system of the present invention. As shown in FIG. 5C, the second wireless communication module 12 comprises a multimedia switcher 12i (e.g. an AV switcher or a HDMI hub), a monitor 12j and an external multimedia player 12k. The multimedia switcher 12i comprises a second wireless receiving/transmitting processing unit 121. The second wireless receiving/transmitting processing unit 121 comprises a wireless signal converter 1211 and a switching device 1215. The switching device 1215 is connected with the wireless signal converter 1211. The external multimedia player 12k is connected with the switching device 1215. The external multimedia player 12k comprises an optical disc player 12k1 and/or a game console 12k2.

The monitor 12j comprises a multimedia data outputting unit 122. The multimedia data outputting unit 122 comprises a multimedia signal outputting part 1221 and a multimedia signal processor 1222. The multimedia signal processor 1222 is connected with the switching device 1215 of the second wireless receiving/transmitting processing unit 121. The multimedia data contained in the multimedia data packet from the second wireless receiving/transmitting processing unit 121 is processed by the multimedia signal processor 1222, and then played and outputted by the multimedia signal outputting part 1221. According to the switching remote control signal contained in the first remote control data packet 221 of the data flow 2, the switching device 1215 is controlled to be switched, turned on or turned off. Consequently, a desired video source is selected to be displayed on the monitor 12j.

FIG. 5D is a schematic functional block diagram illustrating a further exemplary second wireless communication module used in the wireless communication system of the present invention. As shown in FIG. 5D, the second wireless communication module 12 is a tablet personal computer or a wirelessly-controlled and touch-controlled monitor 12d. The second wireless communication module 12 comprises a second wireless receiving/transmitting processing unit 121, a multimedia data outputting unit 122, an antenna 123, a human-machine interface 125, a controller 126, a fourth wireless receiving/transmitting processing unit 127 and an antenna 128. The second wireless receiving/transmitting processing unit 121 comprises a wireless signal converter 1211 connected with the antenna 123 and the multimedia data outputting unit 122. The second wireless receiving/transmitting processing unit 121 is configured to receive, transmit and process the multimedia data packet of the data flow. The fourth wireless receiving/transmitting processing unit 127 comprises a wireless signal converter 1271 connected with the antenna 128 and a human-machine interface signal processor 1272 connected with the wireless signal converter 1271, the controller 126 and the human-machine interface 125. The fourth wireless receiving/transmitting processing unit 127 is configured to receive, transmit and process the control data packet of the data flow. The operating principles and the functions of the components of the first wireless communication module shown in FIG. 5D are similar to those shown in FIG. 5A, and are not redundantly described herein.

From the above description, the wireless communication system of the present invention comprises a first wireless communication module and a second wireless communication module. The first wireless communication module and the second wireless communication module comprises a first wireless receiving/transmitting processing unit and a second wireless receiving/transmitting processing unit, respectively. In addition, the multimedia data packet and the control data packet of the data flow are transmitted between the first wireless communication module and the second wireless communication module according to the non-IEEE standard communication protocol by using a symmetric data transmission technology or an asymmetric data transmission technology. According to the touch remote control signal, the remote control signal, the click remote control signal, the mouse cursor remote control signal and/or the keyboard input remote control signal (HIDs signal) contained in the control data packet of the data flow, the first wireless communication module is remotely controlled. In addition, according to the infrared remote control signal, the Zigbee remote control signal and/or the switcher remote control signal contained in the control data packet of the data flow, the second wireless communication module is remotely controlled. Since it is not necessary to install an additional antenna or an additional wireless chip within the first wireless communication module of the present invention, the internal space and the power consumption will be reduced. In other words, the first wireless communication module of the present invention is more cost-effective. Since the multimedia data stored in the first wireless communication module may be transmitted to the second wireless communication module, the multimedia data may be viewed through a larger screen. Moreover, by inputting a control signal through the second wireless communication module, the displaying image of the first wireless communication module may be simultaneously displayed on dual screens in order to increase the value of using the first wireless communication module. Moreover, since the multimedia data packet and the control data packet of the data flow are transmitted according to the wireless communication protocol by integrating with non-IEEE standard digital protocol wireless system, IEEE standard digital protocol wireless network system or analog wireless network system and by using the symmetric data transmission technology or the asymmetric data transmission technology, if we select non-IEEE standard digital protocol wireless system, no complex protocol is used and the loading of the processor of the second wireless communication module is not largely increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless communication system with a remote control function, said wireless communication system comprising:
a first wireless communication module comprising at least one wireless receiving/transmitting processing unit, wherein said at least one wireless receiving/transmitting processing unit is configured to receive, transmit and process a data flow comprising a multimedia data packet and a control data packet; and
a second wireless communication module comprising at least one wireless receiving/transmitting processing unit and a multimedia data outputting unit, wherein said at least one wireless receiving/transmitting processing unit is configured to receive, transmit and process said data flow, and a multimedia data signal contained in said multimedia data packet is outputted from said multimedia data outputting unit,
wherein said data flow is wirelessly transmitted between said first wireless communication module and said second wireless communication module according to a wireless communication protocol, said control data packet of said data flow comprises a first remote control data packet and a second remote control data packet, said first remote control data packet contains an infrared remote control signal, a Zigbee remote control signal or a switcher remote control signal so that said second wireless communication module is remotely controlled by said first wireless communication module according to said first remote control data packet, and said second remote control data packet contains a touch remote control signal, a joystick remote control signal, a click remote control signal, a mouse cursor remote control signal or a keyboard input remote control signal so that said first wireless communication module is remotely controlled by said second wireless communication module according to said second remote control data packet.

2. The wireless communication system according to claim 1 wherein said first wireless communication module is a smart phone, an internet access device, a combination of a smart phone and a mobile battery, a personal digital assistant, a notebook computer, an IPTV box, an Apple TV, a Google TV box, a PC or a tablet personal computer.

3. The wireless communication system according to claim 1 wherein said second wireless communication module is a wirelessly-controlled and touch-controlled monitor, a combination of a monitor and a wireless communication adapter, an e-book, a robot, a wireless projector, a combination of a projector and a wireless communication adapter, a wireless head mounted display, a combination of a head mounted display and a wireless communication adapter, a smart phone or a tablet personal computer.

4. The wireless communication system according to claim 1 wherein said second wireless communication module further comprises at least one remotely-controlled electronic device, said remotely-controlled electronic device is further remotely controlled by said first wireless communication module according to said first remote control data packet, and said remotely-controlled electronic device comprises an infrared remote control device or a Zigbee remote control device.

5. The wireless communication system according to claim 1 wherein said first wireless communication module comprises a first wireless receiving/transmitting processing unit configured to receive, transmit and process said data flow complying with a non-IEEE standard communication protocol, wherein said first wireless receiving/transmitting processing unit comprises a wireless signal converter, a multimedia signal processor and a human-machine interface signal processor, and said human-machine interface signal processor and said multimedia signal processor are respectively connected with said wireless signal converter.

6. The wireless communication system according to claim 1 wherein said first wireless communication module comprises:
a first wireless receiving/transmitting processing unit comprising a wireless signal converter and a multimedia signal processor and configured to receive, transmit and process said multimedia data packet; and
a third wireless receiving/transmitting processing unit comprising a human-machine interface signal processor and a wireless signal converter and configured to receive, transmit and process said control data packet.

7. The wireless communication system according to claim 1 wherein said second wireless communication module comprises a second wireless receiving/transmitting processing unit configured to receive, transmit and process said data flow, wherein said second wireless receiving/transmitting processing unit comprises a wireless signal converter and a human-machine interface signal processor, and said human-machine interface signal processor is connected with said wireless signal converter.

8. The wireless communication system according to claim 1 wherein said second wireless communication module comprises:
a second wireless receiving/transmitting processing unit comprising a wireless signal converter and configured to receive, transmit and process said multimedia data packet; and
a fourth wireless receiving/transmitting processing unit comprising a human-machine interface signal processor and a wireless signal converter and configured to receive, transmit and process said control data packet.

9. The wireless communication system according to claim 1 wherein said second wireless communication module comprises a second wireless receiving/transmitting processing unit, wherein said second wireless receiving/transmitting processing unit comprises a wireless signal converter, an infrared controller and a Zigbee controller, which are included in a wireless communication adapter, wherein said infrared controller and said Zigbee controller are connected with said wireless signal converter.

10. The wireless communication system according to claim 1 wherein said second wireless communication module comprises a second wireless receiving/transmitting processing unit comprising a wireless signal converter and a switching device, which are included in a multimedia switcher, wherein said switching device is connected with said wireless signal converter.

11. The wireless communication system according to claim 1 wherein said multimedia data packet and said control data packet of said data flow are wirelessly transmitted between said first wireless communication module and said second wireless communication module according to a non-IEEE standard digital protocol wireless system, an IEEE standard digital protocol wireless network system or an analog wireless network system.

12. The wireless communication system according to claim 1 wherein said multimedia data packet and said control data packet of said data flow are wirelessly transmitted between said first wireless communication module and said second wireless communication module according to a symmetric data transmission technology or an asymmetric data transmission technology.

13. The wireless communication system according to claim 12 wherein according to said asymmetric data transmission technology, said multimedia data packet is transmitted through a higher frequency band of a transmission channel, and said control data packet is transmitted through a lower frequency band of said transmission channel.

14. A wireless communication system with a remote control function, said wireless communication system comprising:
a first wireless communication module comprising at least one wireless receiving/transmitting processing unit, wherein said at least one wireless receiving/transmitting processing unit is configured to receive, transmit and process a data flow comprising a multimedia data packet and a control data packet; and
a second wireless communication module comprising at least one wireless receiving/transmitting processing unit and a multimedia data outputting unit, wherein said at least one wireless receiving/transmitting processing unit is configured to receive, transmit and process said data flow, and a multimedia data signal contained in said multimedia data packet is outputted from said multimedia data outputting unit,
wherein said data flow is wirelessly transmitted between said first wireless communication module and said second wireless communication module according to a wireless communication protocol, said control data packet of said data flow contains a touch remote control signal, a joystick remote control signal, a click remote control signal, a mouse cursor remote control signal or a keyboard input remote control signal so that said first wireless communication module is remotely controlled by said second wireless communication module according to said control data packet.

15. The wireless communication system according to claim 14 wherein said first wireless communication module comprises a first wireless receiving/transmitting processing unit configured to receive, transmit and process said data flow complying with a non-IEEE standard communication protocol, wherein said first wireless receiving/transmitting processing unit comprises a wireless signal converter, a multimedia signal processor and a human-machine interface signal processor, and said human-machine interface signal processor and said multimedia signal processor are respectively connected with said wireless signal converter.

16. The wireless communication system according to claim 14 wherein said first wireless communication module comprises:
a first wireless receiving/transmitting processing unit comprising a wireless signal converter and a multimedia signal processor and configured to receive, transmit and process said multimedia data packet; and
a third wireless receiving/transmitting processing unit comprising a human-machine interface signal processor and a wireless signal converter and configured to receive, transmit and process said control data packet.

17. The wireless communication system according to claim 14 wherein said second wireless communication module comprises a second wireless receiving/transmitting processing unit configured to receive, transmit and process said data flow, wherein said second wireless receiving/transmitting processing unit comprises a wireless signal converter and a human-machine interface signal processor, and said human-machine interface signal processor is connected with said wireless signal converter.

18. The wireless communication system according to claim 14 wherein said second wireless communication module comprises:
a second wireless receiving/transmitting processing unit comprising a wireless signal converter and configured to receive, transmit and process said multimedia data packet; and
a fourth wireless receiving/transmitting processing unit comprising a human-machine interface signal processor and a wireless signal converter and configured to receive, transmit and process said control data packet.

19. The wireless communication system according to claim 14 wherein said multimedia data packet and said control data packet of said data flow are wirelessly transmitted between said first wireless communication module and said second wireless communication module according to a non-IEEE standard digital protocol wireless system, an IEEE standard digital protocol wireless network system or an analog wireless network system.

20. The wireless communication system according to claim 14 wherein said multimedia data packet and said control data packet of said data flow are wirelessly transmitted between said first wireless communication module and said second wireless communication module according to a symmetric data transmission technology or an asymmetric data transmission technology.

21. The wireless communication system according to claim 20 wherein according to said asymmetric data transmission technology, said multimedia data packet is transmitted through a higher frequency band of a transmission channel, and said control data packet is transmitted through a lower frequency band of said transmission channel.

22. A wireless communication system with a remote control function, said wireless communication system comprising:
a first wireless communication module comprising at least one wireless receiving/transmitting processing unit, wherein said at least one wireless receiving and transmitting unit is configured to receive, transmit and process a data flow comprising a multimedia data packet and a control data packet; and
a second wireless communication module comprising at least one wireless receiving/transmitting processing unit and a multimedia data outputting unit, wherein said at least one wireless receiving/transmitting processing unit is configured to receive, transmit and process said data flow, and a multimedia data signal contained in said multimedia data packet is outputted from said multimedia data outputting unit,
wherein said data flow is wirelessly transmitted between said first wireless communication module and said second wireless communication module according to a wireless communication protocol, said control data packet of said data flow contains an infrared remote control signal, a Zigbee remote control signal or a switcher remote control signal so that said second wireless communication module is remotely controlled by said first wireless communication module according to said control data packet.

23. The wireless communication system according to claim 22 wherein said first wireless communication module comprises a first wireless receiving/transmitting processing unit configured to receive, transmit and process said data flow complying with a non-IEEE standard communication protocol, wherein said first wireless receiving/transmitting processing unit comprises a wireless signal converter, a multimedia signal processor and a human-machine interface signal processor, and said human-machine interface signal processor and said multimedia signal processor are respectively connected with said wireless signal converter.

24. The wireless communication system according to claim 22 wherein said first wireless communication module comprises:
a first wireless receiving/transmitting processing unit comprising a wireless signal converter and a multimedia signal processor and configured to receive, transmit and process said multimedia data packet; and
a third wireless receiving/transmitting processing unit comprising a human-machine interface signal processor and a wireless signal converter and configured to receive, transmit and process said control data packet.

25. The wireless communication system according to claim 22 wherein said second wireless communication module comprises a second wireless receiving/transmitting processing unit configured to receive, transmit and process said data flow, wherein said second wireless receiving/transmitting processing unit comprises a wireless signal converter and a human-machine interface signal processor, and said human-machine interface signal processor is connected with said wireless signal converter.

26. The wireless communication system according to claim 22 wherein said second wireless communication module comprises:
a second wireless receiving/transmitting processing unit comprising a wireless signal converter and configured to receive, transmit and process said multimedia data packet; and
a fourth wireless receiving/transmitting processing unit comprising a human-machine interface signal processor and a wireless signal converter and configured to receive, transmit and process said control data packet.

27. The wireless communication system according to claim 22 wherein said second wireless communication module comprises a second wireless receiving/transmitting processing unit, wherein said second wireless receiving/transmitting processing unit comprises a wireless signal converter, an infrared controller and a Zigbee controller, which are included in a wireless communication adapter, wherein said infrared controller and said Zigbee controller are connected with said wireless signal converter.

28. The wireless communication system according to claim 22 wherein said second wireless communication module comprises a second wireless receiving/transmitting processing unit comprising a wireless signal converter and a switching device, which are included in a multimedia switcher, wherein said switching device is connected with said wireless signal converter.

29. The wireless communication system according to claim 22 wherein said multimedia data packet and said control data packet of said data flow are wirelessly transmitted between said first wireless communication module and said second wireless communication module according to a non-IEEE standard digital protocol wireless system, an IEEE standard digital protocol wireless network system or an analog wireless network system.

30. The wireless communication system according to claim 22 wherein said multimedia data packet and said control data packet of said data flow are wirelessly transmitted between said first wireless communication module and said second wireless communication module according to a symmetric data transmission technology or an asymmetric data transmission technology.

31. The wireless communication system according to claim 30 wherein according to said asymmetric data transmission technology, said multimedia data packet is transmitted through a higher frequency band of a transmission channel, and said control data packet is transmitted through a lower frequency band of said transmission channel.
